(19) United States
(12) Patent Application Publication
(10) Pub. No.: US 2025/0383505 A1
(43) Pub. Date: Dec. 18, 2025

(54) DELAY-LINE QUANTUM MEMORY

(71) Applicant: The Board of Trustees of the University of Illinois, Urbana, IL (US)

(72) Inventors: Paul G. Kwiat, Savoy, IL (US); Nathan Arnold, Urbana, IL (US); Colin Lualdi, Weston, MA (US); Michael E. Goggin, Kirksville, MO (US); Michelle Victora, Urbana, IL (US); Virginia Lorenz, Urbana, IL (US); Kai Shinbrough, Urbana, IL (US)

(21) Appl. No.: 18/665,354

(22) Filed: May 15, 2024

Related U.S. Application Data
(60) Provisional application No. 63/466,883, filed on May 16, 2023.

(51) Int. Cl. G02B 6/28; G02B 6/02; G02B 6/27; G02B 6/293; G02B 6/35; G02F 1/03; G06N 10/40

(52) U.S. Cl. CPC G02B 6/2861; G02B 6/02261; G02B 6/2773; G02B 6/2938; G02B 6/3594; G02F 1/0311; G06N 10/40; G02F 2201/02; G02F 2201/34; G02F 2203/07

(57) ABSTRACT

Example embodiments relate to delay-line quantum memories. One example embodiment includes a device. The device includes a plurality of cascaded optical stages coupled with one another. Each optical stage includes an optical delay line. The optical delay line is configured to receive light at an input. The optical delay line is also configured to propagate light from the input to an output. Light propagates from the input to the output with an associated optical delay time. The optical delay times associated with different optical stages are different from one another. Each optical stage also includes a stage-level recirculation switch configured to receive light at the output of the optical delay line and selectively recirculate the light through the input of the optical delay line. The device also includes a device-level recirculation switch configured to receive light exiting the last optical stage and selectively recirculate the light through the first optical stage.

### CROSS-REFERENCE TO RELATED APPLICATIONS

The present application is a non-provisional patent application claiming the benefit of Provisional Patent Application No. 63/466,883, filed May 16, 2023, the contents of which are hereby incorporated by reference.

### STATEMENT REGARDING FEDERALLY SPONSORED RESEARCH OR DEVELOPMENT

This invention was made with government support under 2016136 awarded by the National Science Foundation. The United States Government has certain rights in the invention.

### BACKGROUND

Unless otherwise indicated herein, the materials described in this section are not prior art to the claims in this application and are not admitted to be prior art by inclusion in this section.

Photonic quantum memories play an important role in several quantum information protocols, including distributed quantum computing, quantum sensing, and the synchronization of repeater nodes. Some photonic memories operate by storing the photon in matter-based systems, but those approaches have limitations. Namely, they are inherently narrow bandwidth, often require costly overhead in the form of cryogenics, and typically have low retrieval efficiency into single-mode fiber.

### SUMMARY

The specification and drawings disclose embodiments that relate to delay-line quantum memories.

In a first aspect, the disclosure describes a device. The device includes a plurality of cascaded optical stages coupled with one another. Each optical stage includes an optical delay line. The optical delay line is configured to receive light at an input. The optical delay line is also configured to propagate light from the input to an output. Light propagates from the input to the output with an associated optical delay time. The optical delay times associated with different optical stages are different from one another. Each optical stage also includes a stage-level recirculation switch configured to receive light at the output of the optical delay line and selectively recirculate the light through the input of the optical delay line. The device also include a device-level recirculation switch configured to receive light exiting a last optical stage of the plurality of optical stages and selectively recirculate the light through a first optical stage of the plurality of optical stages.

In a second aspect, the disclosure describes a device. The device includes a plurality of cascaded optical stages coupled with one another. Each optical stage includes an optical delay line. The optical delay line is configured to receive light at an input. The optical delay line is also configured to propagate light from the input to an output. Light propagates from the input to the output with an associated optical delay time. The optical delay times associated with different optical stages are different from one another. Each optical stage also includes at least one active temperature stabilizer. The active temperature stabilizer includes a photodetector configured to detect one or more calibration signals indicative of a change in an optical path length or an optical alignment associated with the optical delay line in one of the optical stages. The active temperature stabilizer also includes an actuator configured to, in response to the photodetector detecting the change in the optical path length or the optical alignment, counteract the change in the optical path length or the optical alignment by adjusting the optical path length or adjusting the optical alignment.

In a third aspect, the disclosure describes a method. The method includes receiving, at an input of a first optical delay line in a first optical stage, light. The method also includes propagating, by the first optical delay line with an associated first optical delay time, the light from the input of the first optical delay line to an output of the first optical delay line. Additionally, the method includes receiving, by a first stage-level recirculation switch, the light at the output of the first optical delay line. Further, the method includes selectively recirculating, by the first stage-level recirculation switch, the light through the input of the first optical delay line. In addition, the method includes receiving, at an input of a last optical delay line in a last optical stage, the light. Still further, the method includes propagating, by the last optical delay line with an associated last optical delay time, the light from the input of the last optical delay line to an output of the last optical delay line. Even further, the method includes receiving, by a last stage-level recirculation switch, the light at the output of the last optical delay line. Yet further, the method includes selectively recirculating, by the last stage-level recirculation switch, the light through the input of the last optical delay line. Still even further, the method includes receiving, by a device-level recirculation switch, the light exiting the last optical stage. Yet still further, the method includes selectively recirculating, by the device-level recirculation switch, the light through the first optical stage.

The foregoing summary is illustrative only and is not intended to be in any way limiting. In addition to the illustrative aspects, embodiments, and features described above, further aspects, embodiments, and features will become apparent by reference to the figures and the following detailed description.

### BRIEF DESCRIPTION OF THE FIGURES

FIG. 1A is a schematic illustration of a device, according to example embodiments.

FIG. 1B is an illustration of a modified Herriott cell, according to example embodiments.

FIG. 1C is an illustration of a modified Herriott cell, according to example embodiments.

FIG. 2 is a schematic illustration of a device, according to example embodiments.

FIG. 3 is a schematic illustration of a device, according to example embodiments.

FIG. 4 is a schematic illustration of a device, according to example embodiments.

FIG. 5 is a plot of reflectivity of a reflective coating, according to example embodiments.

FIG. 6A is an illustration of a rack-mounted device, according to example embodiments.

FIG. 6B is an illustration of a rack-mounted device, according to example embodiments.

FIG. 7 is a flowchart illustration of a method, according to example embodiments.

While the present invention is susceptible to various modifications and alternative forms, embodiments are shown by way of example in the drawings and are herein described in detail. It should be understood, however, that the description of example embodiments is not intended to be limiting, but on the contrary, the intention is to cover all modifications, equivalents, and alternatives falling within the spirit and scope of the disclosure.

### DETAILED DESCRIPTION

Example methods and systems are described herein. Any example embodiment or feature described herein is not necessarily to be construed as preferred or advantageous over other embodiments or features. The example embodiments described herein are not meant to be limiting. It will be readily understood that certain aspects of the disclosed systems and methods can be arranged and combined in a wide variety of different configurations, all of which are contemplated herein.

Furthermore, the particular arrangements shown in the figures should not be viewed as limiting. It should be understood that other embodiments might include more or less of each element shown in a given figure. In addition, some of the illustrated elements may be combined or omitted. Similarly, an example embodiment may include elements that are not illustrated in the figures.

### I. OVERVIEW

Example embodiments relate to delay-line quantum memories.

Several emerging quantum applications include, or heavily benefit from, the use of quantum memories in their operation. For example, early-stage quantum networking protocols gain a large performance improvement when using photonic quantum memories. As such, different technologies are being considered for the development of a quantum memory that can reliably store and then release photonic quantum bits (qubits). These different technologies can be generally classified into memories that convert photons into a state of matter (matter memory) and memories that allow the photon to travel in a controlled way for a set amount of time (delay-line memory).

Matter memories can involve the conversion of photons into electronic or spin states of a cloud or lattice of atoms. This type of memory may offer deterministic storage and release of photons over a range of storage times and may potentially have high fidelity. In practice, the overall memory bandwidth may be limited by the rate at which a control field can be applied by an external laser, and some matter memories may have an inherently narrow range of optical wavelengths they can store, as the photon being stored must have the exact energy of the excitation in which it is being stored. In addition, matter memories often operate at extremely high or low temperatures, which can necessitate costly infrastructure to operate them. Lastly, transferring the photon into and out of matter memories can introduce undesirable optical loss and noise. Optical loss reduces the storage efficiency of the memory. Optical noise degrades the fidelity of the retrieved quantum state with respect to the input state.

Unlike matter memories, delay-line memories do not transduce the quantum information stored on photons into a different quantum system. Rather, delay-line memories simply delay the photon by an amount of time determined by the travel distance (and index of refraction of the delay-line material). A length of fiber-optic cable is a simple method of introducing such an optical delay. Fiber delays may be stable, cost-effective, and straightforward, but they offer limited tunability (e.g., one cannot change the delay time of fiber by any meaningful amount). While fiber delays can avoid the costly infrastructure and extremely limited wavelength bands of matter memories, fibers offer low optical loss only in a specific wavelength band. Further, fiber-based memories can support photons with quantum information encoded in only a small subset of photonic degrees of freedom (DOF), limiting the amount the quantum information that a single photon stored in the memory can carry.

Example embodiments may include a delay-line approach in which photons are stored in a series of multiplexed, free-space cavities. In some embodiments, the memory operates in free space at room temperature, which may avoid fiber losses and DOF limitations. Unlike fiber memories, free-space memories may be able to store qubits encoded into orbital angular momentum (OAM) modes and spatial modes. Free-space memories may also avoid the costly infrastructure overhead and severe bandwidth restrictions of matter memories since bulk optics may operate over a wide range of wavelengths (with the ranges themselves being highly customizable).

Example embodiments include free-space photonic quantum memories, which can store single photons with the quantum information encoded in one or more photonic degrees of freedom. In some embodiments, example devices allow single photons to travel in a controlled free-space environment by having them reflect between high-reflectivity mirrors, delaying the photons by a fixed amount of time. In some embodiments, the number of times light cycles through the memory may be controlled using a free-space optical switch.

Further, in some embodiments, the memory may demonstrate storage of single photons containing polarization qubits for various durations, with multiple different configurations (e.g., n×12.5+m×125+k×1250 ns, with n, m, k=1, . . . , 10). In various embodiments, multiple types of photonic qubits may be stored within the memory, even allowing for several qubits encoded onto a single photon (e.g., polarization, frequency, time-bin, and spatial mode qubits).

### II. EXAMPLE SYSTEMS

The following description and accompanying drawings will elucidate features of various example embodiments. The embodiments provided are by way of example, and are not intended to be limiting. As such, the dimensions of the drawings are not necessarily to scale.

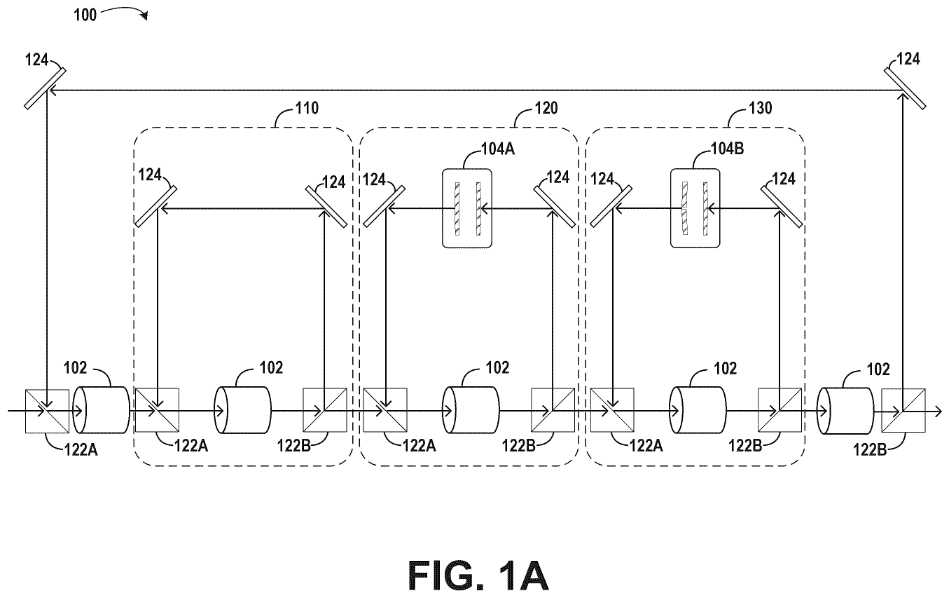

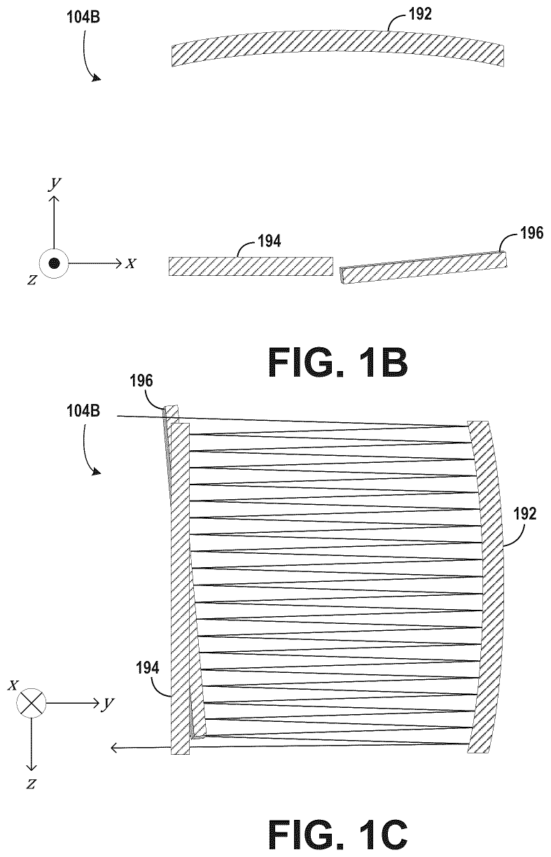

FIG. 1A shows a device 100, according to example embodiments. The device 100 may be a quantum memory, for example. As illustrated, the device 100 may include three multiplexed optical stages 110, 120, 130. The three multiplexed optical stages 110, 120, 130 may each have associated optical delay lines with different associated storage times (e.g., 12.5 ns, 125 ns, and 1.25 μs). For example, the storage time of the delay line of the optical stage 120 may be ten times the storage time of the delay line of the first optical stage 110 and the storage time of the delay line of the third optical stage 130 may be one hundred times the storage time of the delay line of the first optical stage 110 (i.e., the device 100 may be a base-10 quantum memory). While three multiplexed optical stages 110, 120, 130 are illustrated in FIG. 1A, it is understood that other numbers of optical stages are also possible and are contemplated herein (e.g., one, two, four, five, six, seven, eight, etc.). Likewise, other ratios of one delay time to another are also possible and contemplated herein (e.g., the device 100 may not be a base-10 device). For example, the device 100 may be a base-2 device, a base-3 device, a base-4 device, a base-5 device, a base-6 device, a base-7 device, a base-8 device, a base-9 device, a base-11 device, etc.

The device 100 may receive an input signal (e.g., at a left side of FIG. 1A). In some embodiments, the input signal may be an optical signal that includes one or more entangled photons. The input signal may then be provided to a beam splitter 122A (e.g., a polarizing beam splitter). The beam splitters 122A, 122B pictured in FIG. 1A may be polarizing beam splitters. Further, the beam splitters 122A, 122B may be cube beam splitters or plate beam splitters. As just one example, some of the beam splitters 122A, 122B may be a first type of beam splitter (e.g., a cube beam splitter) while other beam splitters 122A, 122B may be a second type of beam splitter (e.g., a plate beam splitter). Further, the beam splitters 122A, 122B may be fabricated using Wollaston prisms, birefringent materials, Brewster's angle polarizing beamsplitter coating, etc. It is noted that, in some embodiments herein, one or more beam splitters (e.g., the beam splitters 122B) may be oriented in reverse (e.g., such that the beam splitters 122B act as beam combiners).

After reaching the first beam splitter 122A, the input signal may pass through a Pockels cell 102 and into the first optical stage 110. After passing out of the first optical stage 110, the signal may pass into and through the second optical stage 120. Thereafter, the signal may pass out of the second optical stage 120 and into and through the third optical stage 130. After leaving the third optical stage 130, the signal may either be recirculated through the entire series of optical stages 110, 120, 130 again (e.g., using the Pockels cell 102 located nearest to the output of the device 100 and reflections from one or more peripheral mirrors 124) and/or may be directed to exit the device (e.g., at an output of the device 100 at the right side of FIG. 1A) by the Pockels cell 102 located nearest to the output of the device 100 via the beam splitter 122B located nearest to the output of the device 100. The combination of the initial Pockels cell 102 (e.g., farthest left in FIG. 1A), the final Pockels cell 102 (e.g., farthest right in FIG. 1A), the initial beam splitter 122A (e.g., farther left in FIG. 1A), and the final beam splitter 122B (e.g., farthest right in FIG. 1A) may form a device-level recirculation switch (though other types of device-level recirculation switches are also possible and contemplated herein, such as an Optical Kerr Shutter (OKS), a nonlinear optical loop mirror, or a Mach-Zehnder Interferometer). In some embodiments, the device-level recirculation switch may be polarization-independent.

As illustrated, a signal may pass through Pockels cell 102 nearest to an input of device 100 and enter the first optical stage 110. The signal may be transmitted through a beam splitter 122A and then provided to a Pockels cell 102. The Pockels cell 102 (e.g., in combination with the beam splitter 122B) may be used to either recirculate the signal through a delay line of the first optical stage 110 or to provide the signal to the second optical stage 120. Hence, the combination of the Pockels cell 102 and the beam splitter 122B may form a stage-level recirculation switch (though other types of stage-level recirculation switches are also possible and contemplated herein, such as an all-optical switch in combination with a polarization-beam splitter). In the example of a device 100 where the optical stages 110, 120, and 130 have delay times that are multiples of the optical stage 110 time and a power of 10, the stage-level recirculation switch (e.g., formed by the Pockels cell 102 and the beam splitter 122B of the first optical stage 110) may repeatedly cause the signal to recirculate through the delay line of the first optical stage 110 (e.g., anywhere from zero to nine times). In some embodiments, the stage-level recirculation switch of the first optical stage 110 may be polarization-independent. Further, in some embodiments, a control signal may be applied to the Pockels cell 102 (e.g., by an external controller) to indicate whether the signal should be recirculated through the delay line of the first optical stage 110. If the signal is recirculated through the first optical stage 110, the signal may pass through a delay line by tracing an optical path (e.g., including being reflected by one or more mirrors 124) and again be provided to the Pockels cell 102 via the first beam splitter 122A. If the signal is not selected for recirculation through the delay line of the first optical stage 110, the signal may pass to the second optical stage 120 via the second beam splitter 122B.

Thereafter, the second optical stage 120 may receive a signal from the first optical stage 110. The signal may be transmitted through a beam splitter 122A and then provided to a Pockels cell 102 of the second optical stage 120. The Pockels cell 102 (e.g., in combination with the beam splitter 122B) may be used to either recirculate the signal through a delay line of the second optical stage 120 or to provide the signal to the third optical stage 130. Hence, the combination of the Pockels cell 102 and the beam splitter 122B may form a stage-level recirculation switch (though other types of stage-level recirculation switches are also possible and contemplated herein, such as an all-optical switch in combination with a polarization-beam splitter). In the example of a base-10 device 100, the stage-level recirculation switch (e.g., formed by the Pockels cell 102 and the beam splitter 122B of the second optical stage 120) may repeatedly cause the signal to recirculate through the delay line of the second optical stage 120 (e.g., anywhere from zero to nine times). In some embodiments, the stage-level recirculation switch of the second optical stage 120 may be polarization-independent. Further, in some embodiments, a control signal may be applied to the Pockels cell 102 (e.g., by an external controller) to indicate whether the signal should be recirculated through the delay line of the second optical stage 120. If the signal is recirculated through the second optical stage 120, the signal may trace out an optical path (e.g., including being reflected by one or more mirrors 124) and again be provided to the Pockels cell 102 via the first beam splitter 122A of the second optical stage 120. If the signal is not selected for recirculation through the delay line of the second optical stage 120, the signal may pass to the third optical stage 130 via the second beam splitter 122B of the second optical stage 120.

Unlike the first optical stage 110, though, the optical path (i.e., the delay line) of the second optical stage 120 may include a Herriott cell 104A (e.g., to extend the duration associated with propagation in the delay line of the second optical stage 120). For example, the Herriott cell 104A (i.e., a multi-pass reflection cavity) may be used to obtain an extended free-space storage time. The Herriott cell 104A may provide a compact cavity that increases optical path length by orders of magnitude greater than the length of the cavity itself. In some embodiments, the Herriott cell 104A may include two spherical mirrors facing each other, with a hole drilled into one or both mirrors for entry/exit after traversing the cell. For example, the Herriott cell 104A may provide a total path length that is 37 times the length of the cavity itself.

After being provided to the third optical stage 130, the signal may be transmitted through a beam splitter 122A and then provided to a Pockels cell 102 of the third optical stage 130. The Pockels cell 102 (e.g., in combination with the beam splitter 122B) may be used to either recirculate the signal through the third optical stage 130 or to provide the signal to a device-level recirculation switch (e.g., formed by the Pockels cell 102 and the beam splitter 122B located to the right of the third optical stage 130 in FIG. 1A). Hence, the combination of the Pockels cell 102 and the beam splitter 122B of the third optical stage 130 may form a stage-level recirculation switch (though other types of stage-level recirculation switches are also possible and contemplated herein, such as an all-optical switch in combination with a polarization-beam splitter). In the example of a device 100 where the optical stages 110, 120, and 130 have delay times that are multiples of the optical stage 110 time and a power of 10, the stage-level recirculation switch (e.g., formed by the Pockels cell 102 and the beam splitter 122B of the third optical stage 130) may repeatedly cause the signal to recirculate through the delay line of the third optical stage 130 (e.g., anywhere from zero to nine times). In some embodiments, the stage-level recirculation switch of the third optical stage 130 may be polarization-independent. Further, in some embodiments, a control signal may be applied to the Pockels cell 102 (e.g., by an external controller) to indicate whether the signal should be recirculated through the delay line of the third optical stage 130. If the signal is recirculated through the third optical stage 130, the signal may trace out an optical path (e.g., including being reflected by one or more mirrors 124) and again be provided to the Pockels cell 102 via the first beam splitter 122A of the third optical stage 130. If the signal is not selected for recirculation through the delay line of the third optical stage 130, the signal may pass to the device-level recirculation switch via the second beam splitter 122B of the third optical stage 130.

Unlike the first optical stage 110 and the second optical stage 120, though, the optical path (i.e., the delay line) of the third optical stage 130 may include a modified Herriott cell 104B (e.g., to extend the duration associated with propagation in the third optical stage 130). For example, the modified Herriott cell 104B (i.e., a multi-pass reflection cavity) may be used to obtain an extended free-space storage time on a 4 ft×6 ft optical table. The modified Herriott cell 104B may provide a compact cavity that increases optical path length by orders of magnitude greater than the length of the cavity itself.

While, in some devices (e.g., the device 100 illustrated in FIG. 1A), the optical stages may be arranged in order of optical delay time (e.g., from shortest optical delay time to longest optical delay time, as in the optical stages 110, 120, 130 illustrated in FIG. 1A), it is understood that other embodiments are also possible and are contemplated herein. As just one example, the device 100 of FIG. 1A could be rearranged such that the order of the optical stages 110, 120, 130 from left to right would be the third optical stage 130, the first optical stage 110, and then the second optical stage 120. Likewise, while the first optical stage 110 includes no cavity, the second optical stage 120 includes a shorter-delay cavity (e.g., the Herriott cell 104A), and the third optical stage 130 includes a longer-delay cavity (e.g., the modified Herriott cell 104B), it is understood that other embodiments are also possible and are contemplated herein. For example, multiple optical stages within a device may include no cavity, multiple optical stages may include a shorter-delay cavity (e.g., a Herriott cell), and/or multiple optical stages may include a longer-delay cavity (e.g., a modified Herriott cell).

An example modified Herriott cell 104B is illustrated in FIGS. 1B and 1C. FIG. 1B illustrates a top view (i.e., along the illustrated z-axis) of the modified Herriott cell 104B and FIG. 1C illustrates a side view (i.e., along the illustrated x-axis) of the modified Herriott cell 104B (note that FIG. 1C also illustrates a hypothetical optical path being traced out by a signal in the modified Herriott cell 104B). While the optical path illustrated in FIG. 1C shows the signal entering and exiting from the same side of the modified Herriott cell 104B along the y-axis, it is understood that, alternatively, the signal may enter and exit from opposite sides of the modified Herriott cell 104B (e.g., enter from the right side of FIG. 1C and exit from the left side). As illustrated, the modified Herriott cell 104B may include three mirrors: a first mirror 192 (e.g., a spherical mirror), a second mirror 194 (e.g., a planar mirror) that faces the first mirror 192, and a third mirror 196 (e.g., a planar mirror) that faces the first mirror 192 and is adjacent to the second mirror 194. As illustrated, the third mirror 196 may be: displaced from the second mirror 194 along a first axis (e.g., the z-axis), rotated relative to the second mirror 194 about the first axis (e.g., the z-axis), and rotated relative to the second mirror 194 about a second axis (e.g., the x-axis).

Unlike a traditional Herriott cell, the modified Herriott cell 104B replaces one of the two spherical mirrors by two square, flat mirrors (e.g., the second mirror 194 and the third mirror 196), with a slight but specific relative tilt between them. Also unlike a traditional Herriott cell, there may be no entry/exit holes drilled into any of the mirrors; rather, one of the square mirrors (e.g., the second mirror 194 or the third mirror 196) may be vertically offset from the other, and the light enters below/exits above the offset mirror. In some embodiments, for example, the modified Herriott cell 104B may provide a total path length that is 340 times the length of the cavity in the modified Herriott cell 104B.

Further, the mirrors 192, 194, 196 may be designed such that their radii of curvature (e.g., the radius of curvature of the first mirror 192) and the separations between the mirrors 192, 194, 196 achieve an “operating point.” By obtaining an operating point, a beam injected at an input point of the modified Herriott cell 104B may be fully contained in the cavity of the modified Herriott cell 104B while reflecting between the mirrors 192, 194, 196 multiple times before exiting through the exit point (in some embodiments, the input and exit points can be the same point).

In a traditional Herriott cell, having two mirrors with radii of curvature R1 and R2, operating points may be obtained when the following equation is satisfied:

$$Cos ( \frac{K π}{N} ) = \sqrt{( 1 - \frac{d}{R 1} ) ( 1 - \frac{d}{R 2} )}$$

where K and N are mutually prime whole numbers (i.e., the greatest common divisor of K and N is 1), and d is the distance between the two mirrors.

If one of the mirrors of a Herriott cell is split into two (or, more generally, one side of the Herriott cell cavity has two mirrors side-by-side, as here in the modified Herriott cell 104B), and one of these two mirrors 194, 196 were to be rotated about a single axis (e.g., the x-axis illustrated in FIGS. 1B and 1C), then it would be possible to re-circulate the beam in the cavity. With rotation of one mirror about a single axis, the optical path in the cavity may trace out stacked elliptical patterns (e.g., rather than tracing out a single elliptical reflection pattern as in a traditional Herriott cell).

Including the rotation parameter allows for adjustment of optical storage times that are integer multiples of the storage time provided by the traditional operating point (i.e., the storage time provided by a traditional Herriott cell with only two mirrors facing each other). However, both a traditional Herriott cell and a modified Herriott cell (where one side of the cavity has two mirrors, and one of these mirrors is rotated about a single axis, e.g., the x-axis) are governed by the same equation for the operating points, in that they only provide discrete operating points. However, with further modifications to the Herriott cell design, the storage time may be continuously adjusted to achieve a specific (i.e., arbitrary) storage time. This continuous storage time has been achieved herein by incorporating another degree of freedom in the design of the modified Herriott cell 104B of FIGS. 1B and 1C (namely, the rotation angle of the third mirror 196 about another axis, e.g., the z-axis). By rotating third mirror 196 about an additional axis, the length of the modified Herriott cell 104B can be modified while simultaneously maintaining storage in the same operating point. Having continuous adjustability of the storage time for a specific application, paired with the extremely large number of solutions for a given set of mirrors, enables a wide range of continuous storage times to be achieved with a single set of mirrors 192, 194, 196.

The design of the modified Herriott cell 104B may allow for storage of several distinct spatial modes at one time. It is possible to simultaneously inject several beams at the same input point, each with different input angles, and each beam will exit at the same output point, also with different angles. In this manner, it is possible to inject so-called “fans” of input beams at different angles that all overlap at the input point, and then collect these beams in the same manner at the output point.

In the device 100 of FIG. 1A, the first optical stage 110 may offer a fine time resolution (e.g., at the expense of low efficiency for long storage times since incorporating a long storage time in a short loop would require multiple passes through the relatively lossy Pockels cell 102 or similar optical switch). The third optical stage 130 (e.g., the last optical stage in the series) may offer high-efficiency storage for long times (e.g., since a long storage time can be realized with one or few passes through the relatively lossy Pockels cell 102 or similar optical switch, but with coarse time resolution since photons cannot be released mid-loop). The number of times a photon is stored in each of the three optical stages 110, 120, 130 may be controlled using the beam splitters 122B (e.g., polarizing beam splitters) and the associated Pockels cell 102 in the respective optical stage 110, 120, 130 acting as a switch. This may allow for the storage of photons for an arbitrary number of cycles in each optical stage 110, 120, 130, but because the storage times of the three optical stages 110, 120, 130 differ from one another (e.g., by a factor of 2, by a factor of 8, by a factor of 10, by a factor of 20, by a factor of 100, etc.), it may maximize efficiency to store the photons a limited number of times in each optical stage 110, 120, 130 (e.g., up to 9 times in the first optical stage 110 and up to 9 times in the second optical stage 120 when the second optical stage 120 has a duration that is 10 times longer than the first optical stage 110 and the third optical stage 130 has a duration that is 10 times longer than the second optical stage). By multiplexing the three optical stages 110, 120, 130, a “digital” memory that can store photons for any number of periods (e.g., periods equal to the duration of the time delay of the delay line of the first optical stage 110) with an exponentially enhanced efficiency falloff compared to using a single time delay/single optical stage.

As described, the device 100 (and other devices described herein) may include modular free-space optical stages (each with a different storage time) that are connected in series. Photons are stored in one storage optical stage at a time and then move on to the next optical stage in the series. Further, though, the device 100 includes a device-level recirculation switch (e.g., the final Pockels cell 102 and beam splitter 122B) that allows for changes in desired storage time after initial receipt of the input signal (e.g., after the signal initially reaches the final Pockels cell 102 in the device, the signal may be recirculated to the first optical stage 110). In an alternative approach (e.g., without the device-level recirculation switch and optical path that brings the signal back to the first optical stage 110), an end-user would need to indicate the desired total storage time prior to the initial signal (e.g., photon) arriving and being stored since the signal (e.g., photon) would not be able re-enter a given optical stage (to accumulate a storage time that can only be provided by that optical stage) after the signal has left the optical stage. By adding an additional optical switch to the end and beginning of the series of optical stages (as illustrated in FIG. 1A), signals (e.g., photons) can be sent back to the beginning of the series of optical stages. This enables the end-user (e.g., based on one or more control signals) to store photons and continuously reconfigure/update the storage time.

This device 100 shown and described with reference to FIG. 1A may be a polarization-dependent quantum memory (e.g., as it makes use of polarization-dependent optics in the switch, such as polarizing beam splitters and Pockels cells, to store photons). In some embodiments, polarization-dependent operation may be undesirable. Though not illustrated in FIG. 1A, in such embodiments, a polarization-independent optical switch that converts an arbitrary polarization state into two different spatial modes at the same polarization may instead be included in the device 100. Because the free-space optics employed in this switch may be large relative to the beam size, all switching operations may be performed equally on the two spatial modes. In some embodiments, each of the switches (e.g., each combination of a beam splitter 122B with a Pockels cell 102) may be replaced with one of these polarization-independent switches. However, since replacing each switch in such a way would mean photons would go through a beam displacer four times in each traversal of the storage loop (e.g., which result in the accumulation of not inconsequential losses), two distinct spatial modes could be used throughout the entire device 100.

Though not illustrated, in some embodiments, the device 100 may also include one or more active stabilizers (e.g., temperature stabilizers). For example, the device 100 may include an active temperature stabilizer that includes a photodetector configured to detect one or more calibration signals indicative of a change in an optical path length associated with the optical delay line in one of the optical stages 110, 120, 130. In some embodiments, for instance, the photodetector may include a fast photodetector with a reference signal configured to detect changes in path length. The active temperature stabilizer may also include an actuator configured to, in response to the photodetector detecting the change in the optical path length, counteract the change in the optical path length by adjusting the optical path length. In some embodiments, the actuator may include a piezoelectric chip and one or more stages configured to adjust a position (e.g., a position along the y-axis) of a mirror of a modified Herriott cell (e.g., the modified Herriott cell 104B shown and described with reference to FIGS. 1A-1C). In some embodiments, the actuator may include a motorized linear actuator and one or more stages configured to adjust a position (e.g., a position along the y-axis) of a mirror of a modified Herriott cell (e.g., the modified Herriott cell 104B shown and described with reference to FIGS. 1A-1C). In some embodiments, only one of the optical stages 110, 120, 130 may include an active temperature stabilizer. Alternatively, multiple of the optical stages 110, 120, 130 (e.g., each optical stage 110, 120, 130) may include an active temperature stabilizer.

Additionally or alternatively, the device 100 may include an active temperature stabilizer that includes a photodetector configured to detect one or more calibration signals indicative of a change in an optical alignment associated with the optical delay line in one of the optical stages 110, 120, 130. In some embodiments, for instance, the photodetector may include a position sensitive detector (PSD) that includes a quadrant cell photoreceiver configured to detect changes in optical alignment. The active temperature stabilizer may also include one or more actuators configured to, in response to the photodetector detecting the change in the optical alignment, counteract the change in the optical alignment by adjusting the optical alignment. In some embodiments, the actuator may include a piezoelectric chip and one or more mounts configured to adjust a tip angle (e.g., an angle about the x-axis) or a tilt angle (e.g., an angle about the z-axis) of a mirror of a modified Herriott cell (e.g., the modified Herriott cell 104B shown and described with reference to FIGS. 1A-1C). In some embodiments, only one of the optical stages 110, 120, 130 may include an active temperature stabilizer. Alternatively, multiple of the optical stages 110, 120, 130 (e.g., each optical stage 110, 120, 130) may include an active temperature stabilizer.

Devices for storing photons in a multiplexed delay-line memory have been described with reference to FIGS. 1A-1C. In some embodiments, the device 100 may be used to store and emit photonic qubits, specifically (e.g., in the form of a time-bin qubit), with high efficiency and fidelity. In some embodiments, rather than operating with only a single input polarization (e.g., as a result of the polarization-dependent switching mechanisms used), the photonic qubit to be stored may first pass through a polarization-to-time-bin transducer, which converts an arbitrary polarization state into a time-bin qubit with a single polarization. In such embodiments, the two temporal qubits may exit the transducer, be stored by the memory (e.g., propagate through the device 100 shown and described with reference to FIG. 1A), and then propagate backwards through a transducer to re-combine, restoring the initial polarization state.

When storing photons in free space, slight temperature fluctuations, in the absence of mitigation techniques, may cause significant deviations in the alignment of a system, especially at longer path lengths. For example, to achieve a storage time of 10 μs, a photon will have traveled about 3 km from end to end. Further, in order to couple light into a single-mode fiber-optic cable with a ˜10 μm diameter, an alignment deviation of 1 μrad at the launch can induce a beam displacement of 3 mm at the output, resulting in the photon entirely missing the single-mode fiber when the fiber-coupling lens (specifically the aperture and effective numerical aperture of the lens) used is not designed to handle a large displacement. With regular thermal cycling from a typical heating, ventilation, and air conditioning (HVAC) system, temperature in a lab can change by several degrees (not to mention the possibly significant temperature changes experienced in an environment with less advanced or no temperature control), which can induce thermal expansion or contraction in optical mounts with potential to cause beam deviations on the order of tens of prad. In some embodiments, to remedy this issue, the components that provide the longest path length within the device 100 may be thermally stabilized and made to withstand both slow, long-term deviations associated with optical mounts drifting and fast, short-term deviations caused by thermal fluctuations.

In some embodiments, thermal stabilization may be accomplished, for example, by injecting a separate stabilization beam into the storage cavity (e.g., the cavity of the modified Herriott cell 104B). The stabilization beam may propagate through the entire storage cavity to achieve the same number of reflections as any other spatial mode would, thereby accumulating all the same beam deflections and deviations caused by different misalignment mechanisms; alternatively, it may suffice for the stabilization beam to stay in the storage cavity for a shorter time. With these deviations applied to the spatial mode of the stabilization beam, the stabilization beam may be retrieved (e.g., using a PSD, such as a quadrant cell photoreceiver (or quad cell)) to measure the magnitude of these deviations. The response signal (e.g., of the PSD) may then be paired with piezoelectric transducers attached to the tip and tilt actuators of one mirror (e.g., the third mirror 196 of the modified Herriott cell 104b) to create a closed-loop feedback system that can actively compensate for any short-term or long-term drifts or deviations in the alignment of the storage cavity.

Active stabilization of the cavity length in a multi-pass reflection cavity (e.g., the Herriott cell 104A or the modified Herriott cell 104B) may provide for practical applications including free-space, delay-line-type quantum memories, as the cavity length may determine the single-loop storage time of the memory. This storage time may be stabilized to within a fraction of one pulse duration for quantum applications that involve two-qubit gates and/or Hong-Ou-Mandel interference between a photon stored in the memory and a photon from a separate source (potentially stored in a separate memory). For 100-fs duration single photons stored in a 10-μs storage loop, this may correspond to length stabilization to better than 30 μm over a length of 3000 m, or better than 1 in 10⁸. The bulk of this storage time and distance may be taken up in the cavity. For example, for a separation between the first mirror 192 and the second mirror 194/the third mirror 196 of 1 m, this corresponds to approximately 3000 reflections, and a small change in the mirror separation is magnified by approximately 6000 times (as a change in the mirror separation of Δx results a 2Δx change in the optical path length). To stabilize the path length to better than 30 μm, the mirror separation may be kept stable to at or below 5 nm, on average. Two approaches to achieve such stabilization are described herein, both of which rely on closed-loop feedback with automated actuators for compensation. However, it is understood that other stabilization techniques are also possible and contemplated herein.

For some quantum communication applications, the path length is roughly stabilized to within 1 mm (e.g., to enable Hong-Ou-Mandel interference), which corresponds to cavity-length changes of only a few μm. Such modifications of cavity length can be implemented using feedback-controlled actuators to actively change the length of the cavity. By sending a short classical pulse through a 50:50 beam splitter, two identical signals can be prepared at the same instant: a reference signal and a storage signal. The storage signal may then be sent through the cavity (e.g., the cavity of the modified Herriott cell 104B) and, subsequently, to a fast detector, whereas the reference signal is sent directly to a fast detector. Assuming the path length of the reference signal is much shorter than the storage signal (and, therefore, that the path length fluctuations are insignificant), fast time-tagging electronics are usable to determine the difference in arrival times between the storage signal and the reference signal (e.g., to within a few ps, which corresponds to ˜1 mm of path length). By pairing this measurement with controllable actuators, compensation of long-term drifts of path length may be achieved. In some embodiments, this technique may not be used for short-term thermal fluctuations because the computations required to determine the path length difference may include analysis of many data points. This approach may also utilize separate spatial and temporal modes to avoid overlap with the modes occupied by any stored photonic qubits.

An alternative approach of maintaining path-length stability (e.g., to within a fraction of wavelength) may include using interference effects in conjunction with a controllable actuator to change a cavity length (e.g., a cavity length of the modified Herriott cell 104B). With an ultranarrow-linewidth continuous-wave (CW) laser source (e.g., with a coherence length at least as long as to the optical path length of the storage cavity), an unbalanced Mach-Zehnder interferometer can be created (e.g., in which one arm of the interferometer includes the cavity and the other arm does not). By splitting the CW laser at a 50:50 beam splitter into two paths (e.g., a reference path and a storage path), the storage path can be sent through one of the many spatial modes of the cavity (e.g., which does not hinder the cavity's ability to store quantum signals in the other spatial modes) and then the two paths may be recombined on a subsequent 50:50 beam splitter to achieve interference. By placing detectors in both output arms of the interferometer and monitoring the interference fringes, any fluctuations in the path length of the cavity may be determined. This measurement requires relatively little post-processing compared to the previously mentioned technique and can be combined with a controllable actuator to create a closed-loop system to compensate for wavelength-scale changes in the optical path length of the cavity in real time, assuming that the stabilization laser frequency is very stable in time. By actively locking on the linear portion of a fringe, stabilization to less than a nanometer may be possible.

Yet another alternative approach of maintaining path-length stability may include using a laser with a stable repetition rate, with inter-pulse spacing equal to the desired storage time of an optical delay. Second Harmonic Generation may then be performed using two adjacent pulses and the generated signal may be detected, which is synchronous due to the optical delay being equal to the time separation of the pulses. This nonlinear correlation may achieve improved timing correlations than direct detection.

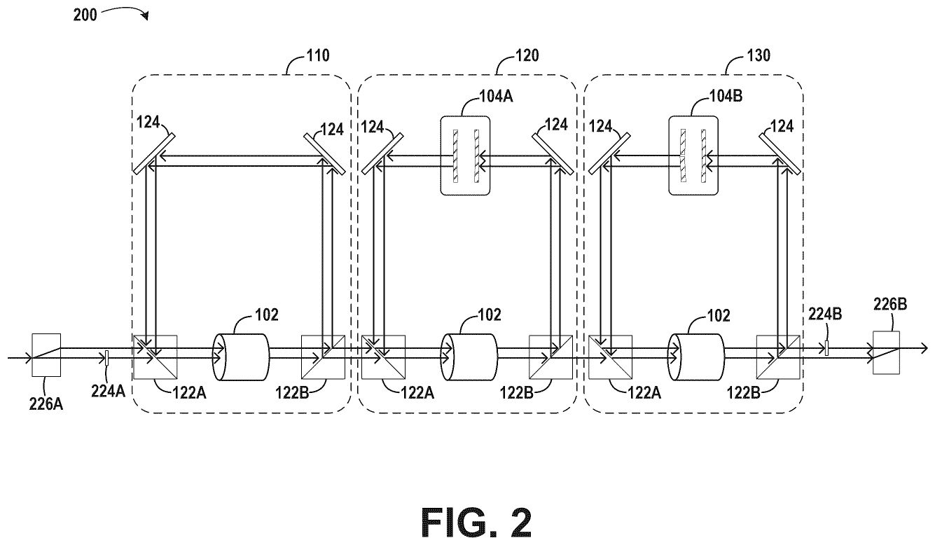

FIG. 2 is an illustration of a device 200, according to example embodiments. Like the device 100 shown and described with reference to FIG. 1A, the device 200 may include a first optical stage 110, a second optical stage 120, and a third optical stage 130. Each optical stage 110, 120, 130 may include a Pockels cell 102, beam splitters 122A, 122B, and one or more mirrors 124. Further, also like the device 100 shown and described with reference to FIG. 1A, the second optical stage 120 of the device 200 may include a Herriott cell 104A and the third optical stage 130 of the device 200 may include a modified Herriott cell 104B. Unlike the device 100 of FIG. 1A, though, the device 200 does not include a device-level recirculation switch/a device-level recirculation path (e.g., does not include an additional set of beam splitters 122A, 122B, additional mirrors 124, or an additional Pockels cell 102 for recirculating a signal through the entire device 200). Also, unlike the device 100 of FIG. 1A, the device 200 may include a first half-wave plate 224A, a second half-wave plate 224B, an input beam displacer 226A, and an output beam displacer 226B.

The input beam displacer 226A may be configured to receive an input beam (e.g., at the left end of the device 200 illustrated in FIG. 2). The input beam displacer 226A may also be configured to split the input beam into a first beam with a first spatial mode and a second beam with a second spatial mode. The first beam may be provided, by the input beam displacer 226A, to an input of the first optical stage 110. The second beam may be provided, by the input beam displacer 226A, to the first half-wave plate 224A.

The first half-wave plate 224A may be configured to receive the second beam from the input beam displacer 226A. The first half-wave plate 224A may also be configured to rotate the polarization of the second beam. Additionally, the first half-wave plate 224A may be configured to provide the second beam with the rotated polarization to the input of the first optical stage 110.

The second half-wave plate 224B may be configured to receive the first beam from an output of a last optical stage (e.g., the third optical stage 130 illustrated in FIG. 2). The second half-wave plate 224B may also be configured to rotate the polarization of the first beam. Additionally, the second half-wave plate 224B may be configured to provide the first beam with the rotated polarization to the output beam displacer 226B.

The output beam displacer 226B may be configured to receive the first beam with the rotated polarization from the second half-wave plate 224B. The output beam displacer 226B may also be configured to receive the second beam with the rotated polarization from the output of the last optical stage (e.g., the third optical stage 130 illustrated in FIG. 2). Additionally, the output beam displacer 226B may be configured to combine the first beam with the rotated polarization and the second beam with the rotated polarization into an output beam with a single spatial mode. The output beam may be provided at an output of the device 200 (e.g., at the right end of the device 200 illustrated in FIG. 2).

Multi-pass reflection cavities (e.g., the Herriott cell 104A and the modified Herriott cell 104B in the device 200 of FIG. 2) may support multiple spatial modes. By splitting an arbitrary polarization input into two spatial modes and storing those modes in the same storage optical stages 110, 120, 130, the quantum memory (i.e., the device 200) achieves multi-mode storage capabilities. In such embodiments, each polarization component may receive the same storage time and then be recombined at the output into the initial polarization state.

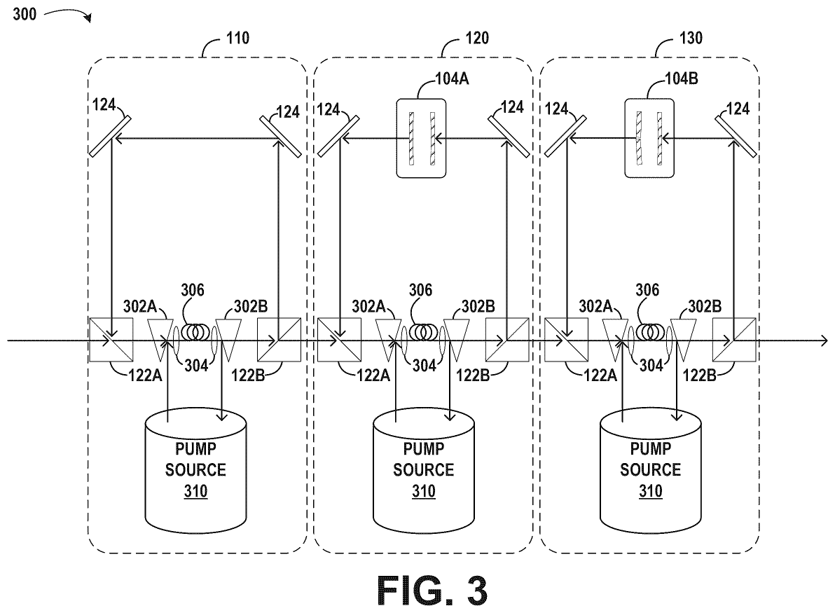

FIG. 3 is an illustration of a device 300, according to example embodiments. Like the device 100 shown and described with reference to FIG. 1A, the device 200 may include a first optical stage 110, a second optical stage 120, and a third optical stage 130. Each optical stage 110, 120, 130 may include beam splitters 122A, 122B and one or more mirrors 124. Further, also like the device 100 shown and described with reference to FIG. 1A, the second optical stage 120 of the device 200 may include a Herriott cell 104A and the third optical stage 130 of the device 200 may include a modified Herriott cell 104B. Unlike the device 100 of FIG. 1A, though, the device 300 does not include a device-level recirculation switch/a device-level recirculation path (e.g., does not include an additional set of beam splitters 122A, 122B, additional mirrors 124, or an additional Pockels cell 102 for recirculating a signal through the entire device 300). Also unlike the device 100 of FIG. 1A, the optical stages 110, 120, 130 of the device 300 do not include Pockels cells 102. Instead, the Pockels cell 102 in each optical stage 110, 120, 130 has been replaced by a first dichroic mirror 302A, a second dichroic mirror 302B, two fiber-coupling lenses 304, and an optical fiber 306 pumped by a pump source 310 (e.g., a pump laser). It is understood that, while separate pump sources 310 are associated with each of the optical stages 110, 120, 130 in FIG. 3, in some embodiments, the device 300 may include a shared pump source (e.g., a pump source shared between the first optical stage 110 and the second optical stage 120, a pump source shared between the first optical stage 110 and the third optical stage 130, a pump source shared between the second optical stage 120 and the third optical stage 130, or a pump source shared between all three optical stages 110, 120, 130).

As such, each of the optical stages 110, 120, 130 may include a fiber-optic switch as a stage-level recirculation switch. Though not illustrated in FIG. 3, in some embodiments (e.g., like the device 100 illustrated in FIG. 1A), the device 300 may also include a device-level recirculation switch. In such embodiments, the device-level recirculation switch may also include a fiber-optic switch. Further, while only a single optical fiber 306 is illustrated in each optical stage 110, 120, 130 of the device 300, in some embodiments, each of the optical stages may include a first optical fiber and a second optical fiber spliced together into a single loop (e.g., where the first optical fiber includes a silica fiber and the second optical fiber includes a dispersion compensating fiber).

In some embodiments (e.g., as in the device 100 shown and described with reference to FIG. 1A), switching may take place using bulk Pockels cells 102. However, such Pockels cells may have slower switching speeds (e.g., leading to a memory that has a lower temporal resolution) and/or lower repetition rates (e.g., disabling higher-rate operations for quantum networking applications) than on-chip electro-optic modulators. Still, electro-optic modulators may include higher insertion losses due to fiber-waveguide mode mismatch. A fast, low-loss alternative, however, may include an all-optical technique called cross-phase modulation (XPM), in which an intense pump pulse induces birefringence in an optical fiber. Such a technique may be used for switching between the optical stages 110, 120, 130 in the device 300 illustrated in FIG. 3, for example. Further, this technique may be used to encode a phase shift on a co-propagating single-photon signal (e.g., at a different wavelength from the pump) as it “walks over” the pump pulse in the optical fiber, thereby transforming the polarization of the signal. Placed between crossed polarizers, this device forms a polarization-based switch, referred to as an Optical Kerr Shutter (OKS), which can be used to switch single photons at 685 nm with >97% efficiency at ˜ps switching speeds. An OKS may be used to replace the bulk Pockels cells 102 in free-space quantum memories, as described herein.

An ideal quantum memory would be able to store multiple qubits at one time in a Random Access Memory (RAM) fashion. The device 300 of FIG. 3, for example, can achieve such RAM storage of multiple photonic qubits at one time based on the optical switching technology used and the broad-bandwidth compatibility. Fast optical switches (e.g., the OKS described above) can be used to select individual pulses and/or photons out of a train of pulses and/or photons passing through the fast optical switch. Similarly, fast optical switches (e.g., the OKS described above) can be used to load and unload distinct photons into and out of an optical stage 110, 120, 130 at any given time by activating the switching mechanism while only the desired photon is in the switching medium. This may allow for the storage of photons for an arbitrary number of storage cycles and the emission of the stored photons later in any desired order. This may only be possible if incoming and outgoing photons do not overlap with each other (e.g., meaning the photons are individually addressable). Additionally, the ability of a switch to select individual signals may depend on technology-specific factors, such as rise time, fall time, minimum on time, minimum off time, and/or dead time. As such, the number of temporal modes that are storable and addressable by the optical stages 110, 120, 130 illustrated in FIG. 3 at a given time is determined by the time-bandwidth product of the respective optical stage 110, 120, 130 (which is equal to the storage time of the delay line of an optical stage 110, 120, 130 multiplied by the optical bandwidth of the respective optical stage 110, 120, 130). In some embodiments (e.g., when the stored photons do not have the same optical bandwidth as the respective optical stage 110, 120, 130), then the number of temporal modes may be equal to the storage time divided by the pulse width of the photons being stored.

In some embodiments, engineering constraints of the optical switch technology used may affect the ability of the device 300 to store or address distinct photonic qubits. Some switching technologies have moderately long minimum on times (compared to the pulse duration of the photons being stored), so when the switching mechanism is activated, the switching mechanism is on for much longer than the duration of one photon passing through it. This may result in more than simply the intended photon being switched into or out of the respective optical stage 110, 120, 130. Hence, the new number of temporal modes that are individually addressable in a given optical stage 110, 120, 130 may be given by the storage time of the respective optical stage 110, 120, 130 divided by the minimum on time of the switching mechanism of the respective optical stage 110, 120, 130.

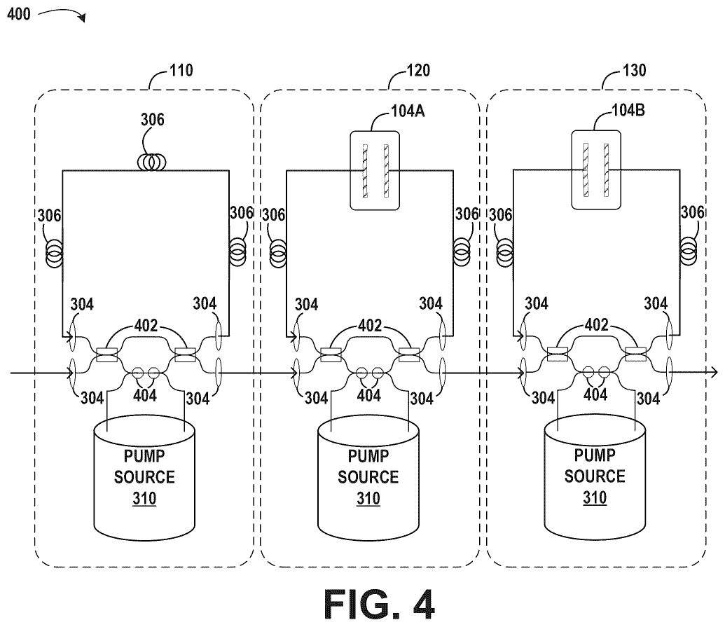

Since the switching process in the OKS scheme is polarization-based, such a technique cannot be used, however, for switching polarization-entangled qubits. Still, a polarization-insensitive design can be implemented using a nonlinear optical loop mirror or a Mach-Zehnder Interferometer configuration. FIG. 4, for example, illustrates a device that provides a polarization-insensitive design.

FIG. 4 is an illustration of a device 400, according to example embodiments. Like the device 100 shown and described with reference to FIG. 1A, the device 400 may include a first optical stage 110, a second optical stage 120, and a third optical stage 130. Like the device 100 shown and described with reference to FIG. 1A, the second optical stage 120 of the device 400 may include a Herriott cell 104A and the third optical stage 130 of the device 400 may include a modified Herriott cell 104B. It is understood that, in some embodiments, there may be coupling optics in the second optical stage 120 to couple to the Herriott cell 104A and in the third optical stage 130 to couple to the modified Herriott cell 104B (e.g., and that these coupling optics have been omitted from the illustration of FIG. 4 to avoid obscuring the rest of the illustration). Unlike the device 100 of FIG. 1A, though, the device 400 does not include a device-level recirculation switch/a device-level recirculation path (e.g., does not include an additional set of beam splitters 122A, 122B, additional mirrors 124, or an additional Pockels cell 102 for recirculating a signal through the entire device 400). Also unlike the device 100 of FIG. 1A, the optical stages 110, 120, 130 of the device 400 do not include Pockels cells 102, beam splitters 122A, 122B (e.g., do not include free-space beam splitters), or mirrors 124. Instead, the Pockels cells 102, beam splitters 122A, 122B, and mirrors 124 in each optical stage 110, 120, 130 have been replaced by fiber-coupling lenses 304, optical fibers 306, pump sources 310 (e.g., pump lasers), fiber beam splitters 402, and wavelength division multiplexers 404. It is understood that, while separate pump sources 310 are associated with each of the optical stages 110, 120, 130 in FIG. 4, in some embodiments, the device 400 may include a shared pump source (e.g., a pump source shared between the first optical stage 110 and the second optical stage 120, a pump source shared between the first optical stage 110 and the third optical stage 130, a pump source shared between the second optical stage 120 and the third optical stage 130, or a pump source shared between all three optical stages 110, 120, 130).

As described above, the principle of operation behind free-space delay-line type quantum memories can be extended to the use of fiber-optic delay-line type quantum memories. Here, the free-space fast optical switches may be replaced by fiber-optic switches, and the free-space propagation of the signal field may be replaced by propagation in low-loss optical fibers. In general, the free-space approach may offer lower losses (higher efficiencies) and little or no dispersion of the signal field. Dispersion may be higher for fiber-optic delay line-type quantum memories, as a 100-fs signal field pulse sent into 1 km of fiber (approximately 5 μs of storage time) will be stretched to a duration of more than 600 ps (an increase of >10⁴) in standard optical fiber. This may present a challenge for broadband photonic time-bin qubits, for example, and/or when it comes to the indistinguishability of the photons retrieved from the memory, as the dispersion and, therefore, the pulse duration and temporal phase varies depending on how long the signal was stored. This can be remedied, however, by splicing two fibers together to form a single dispersionless loop, where one fiber is a standard silica fiber and the second fiber is dispersion compensating fiber, if the length of the dispersion compensating fiber is carefully chosen to counteract the dispersion of the first fiber. In some embodiments, slightly more dispersion-compensating fiber may be included to compensate for any dispersion in the fiber-optic switch.

The technique of splicing together an optical fiber with a dispersion-compensating optical fiber may also provide for a pre-storage buffer system, which can be used in combination with a free-space, delay-line type quantum memory (e.g., as described herein) in cases where a large initial delay is desired without readout capabilities (e.g., generation-1 quantum repeaters or other quantum technologies that include round-trip synchronization).

In some embodiments (e.g., for a free-space memory based on reflective cavities), it may result in higher resulting output signal if the optics used have very low loss (e.g., where the loss of the mirrors 124 in the device 100 is less than the loss of the Pockels cells 102 and beam splitters 122A, 122B). In some embodiments, for example, the mirrors 124 may have a corresponding loss of less than 0.05%. This may provide for enhanced efficiency scaling when multiplexing. As such, in some embodiments, the mirrors in the Herriott cell 104 and/or the modified Herriott cell 104B (and/or any lenses in the device 100) may have a reflectivity (transmission) of ≥99.95%.

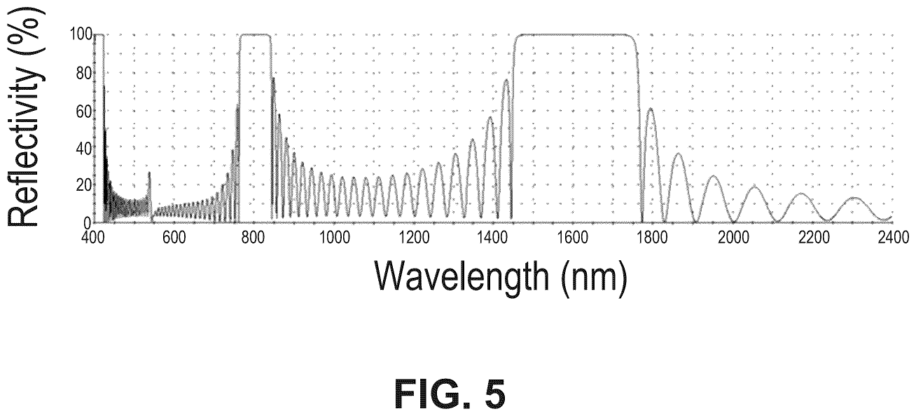

FIG. 5 is a plot showing reflectivity (e.g., in %) of a reflective coating relative to the wavelength (e.g., in nm) of a signal interacting with the reflective coating, according to example embodiments. The reflective coating may correspond to a reflective coating used in a device as described herein (e.g., the device 100 shown and described with reference to FIG. 1A). For example, the reflective coating may be applied to one or more of the mirrors 124 or beam splitters 122A, 122B to reduce signal loss when a signal propagates within the device 100. Additionally or alternatively, the reflective coating may be applied to one or more mirrors of the Herriott cell 104A or the modified Herriott cell 104B (e.g., applied to reflective surfaces of the first mirror 192, the second mirror 194, or the third mirror 196 shown and described with reference to FIGS. 1B and 1C). In some embodiments, an anti-reflective coating may also be applied to one or more components of the device 100 (e.g., an anti-reflective coating may be applied to one or more of the Pockels cells 102 of the device 100 illustrated in FIG. 1A).

As illustrated in FIG. 5, the reflectivity may be high (e.g., near 100%) in one or more wavelength ranges (e.g., in a wavelength range about 100 nm wide and centered on about 800 nm and in another wavelength range about 300 nm wide and centered on about 1600 nm) and fall off for wavelengths outside of those ranges. In some embodiments, for example, the optical delay lines of one or more optical stages (e.g., the optical stages 110, 120, 130 shown and described with reference to FIG. 1A) may include a reflective coating, a reflectivity of the reflective coating may be greater than 99.995% for all wavelengths within a first wavelength range and a second wavelength range, and the first wavelength range and the second wavelength range may span at least 75 nm (e.g., the first wavelength range may span from about 750 nm to about 850 nm and the second wavelength range may span from about 1450 nm to about 1750 nm). The ranges of wavelengths having high reflectivities may be designed to be compatible with a signal wavelength that is intended to be stored within the device 100, for example.

The free-space devices shown and described herein may not include any light-matter interaction, meaning the wavelength bandwidth is only limited by the bandwidth of the optics used and the effective bandwidth of the Pockels cells 102. Traditional high-reflectivity mirror coatings operate well over a wavelength range of tens of nm. In some cases, Pockels cells 102 may operate in a wavelength-dependent fashion, which can limit the effective bandwidth of a device. For example, Pockels cells 102 may have imperfect transmission and relatively low intrinsic extinction ratio (e.g., <1000:1). Along with a large bandwidth, devices described herein also may have considerably long storage times in the longer delay lines. In applications where the first optical stage 110 has a 12.5-ns delay time, the second optical stage 120 has a 125-ns delay time, and the third optical stage 130 has a 1.25-μs delay time, the time-bandwidth products of the three optical stages are 105, 106, and 107, respectively. In some embodiments, the time-bandwidth product of the memory, as a whole, may be limited by the repetition rate of the Pockels cells 102, which may, in some cases, be 2 MHz at most. It is understood that the devices herein are not limited by such a repetition rate, however. For example, future optical switches (e.g., switches operating well into the GHz regime) are contemplated herein and are also possible.

Along with the other metrics mentioned above, example embodiments herein may correspond to quantum memories having high fidelity (i.e., the ability to preserve the quantum information encoded onto the stored photons). By performing polarization state process tomographies of the polarization-to-time-bin transducer and all three optical stages 110, 120, 130 in the device 100 of FIG. 1A, it was determined that the average χ-fidelity of the transducer may be about 99.12(4) % and of the first optical stage 110 (e.g., 12.5-ns delay line), second optical stage 120 (e.g., 125-ns delay line), and third optical stage 130 (e.g., 1.25-μs delay line) to be 99.35(25) %, 99.0(1) %, and 97.8(2) %, respectively. The fidelity of the polarization qubits may be limited, in some embodiments, by the extinction ratio of the polarizing optics (e.g., the Pockels cells 102 and the beam splitters 122A, 122B).

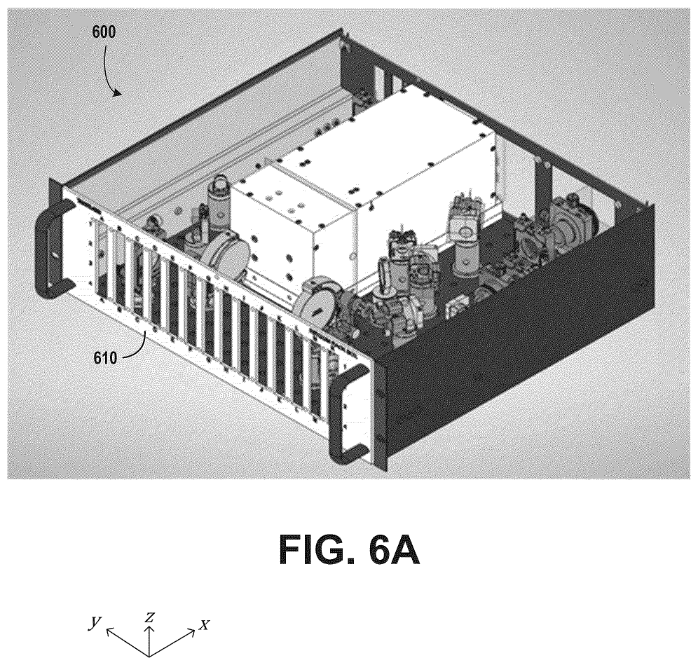

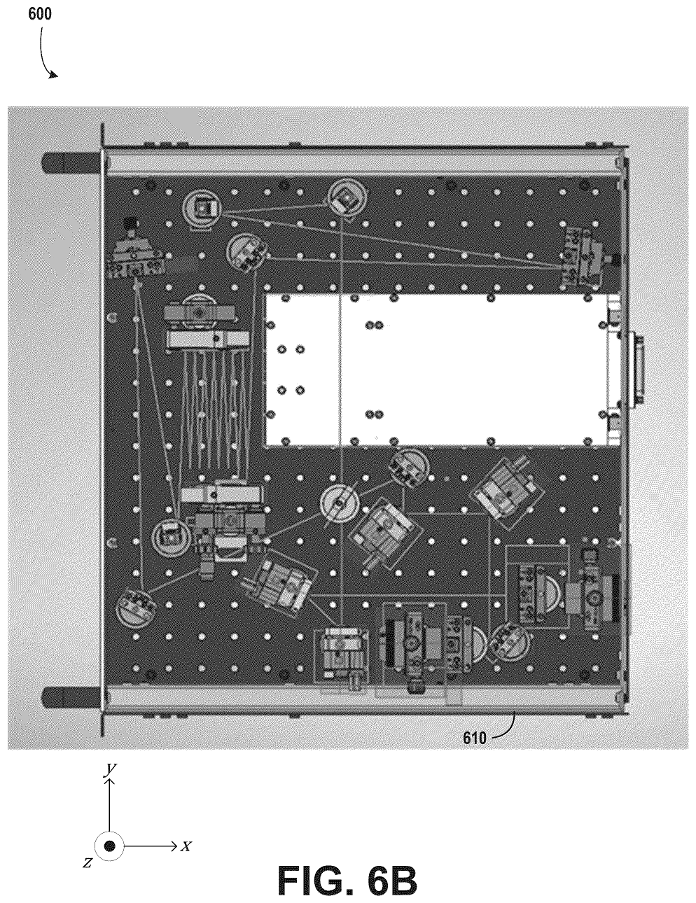

As described above, embodiments described herein may provide for quantum memories. To provide modular memories that can be used (e.g., as an extension to a quantum computing device), some embodiments may include a rack-mounted device. For example, FIGS. 6A and 6B illustrate a rack-mounted device 600 (FIG. 6A from an isometric view and FIG. 6B from a top view). As illustrated, the rack-mounted device 600 may include a rack mount 610. In some embodiments, for example, the rack-mounted device 600 may include all the components of a device (e.g., the device 100 shown and described with reference to FIG. 1A, the device 200 shown and described with reference to FIG. 2, the device 300 shown and described with reference to FIG. 3, or the device 400 shown and described with reference to FIG. 4) mounted within the rack mount 610. For example, the optical stages 110, 120, 130 and the device-level recirculation switch illustrated in FIG. 1A may be arranged on a relatively small optical breadboard and then attached to a standard rack mount (e.g., a 19″, 3 U rack mount chassis).

Hence, the rack-mounted device 600 of FIGS. 6A and 6B, unlike other free-space quantum memories, is not simply arranged on a large (e.g., 4 feet×10 feet) optical breadboard. Further, even without the use of a large optical breadboard, the rack-mounted device 600 might not require any vibration-noise isolation.

### III. EXAMPLE PROCESSES

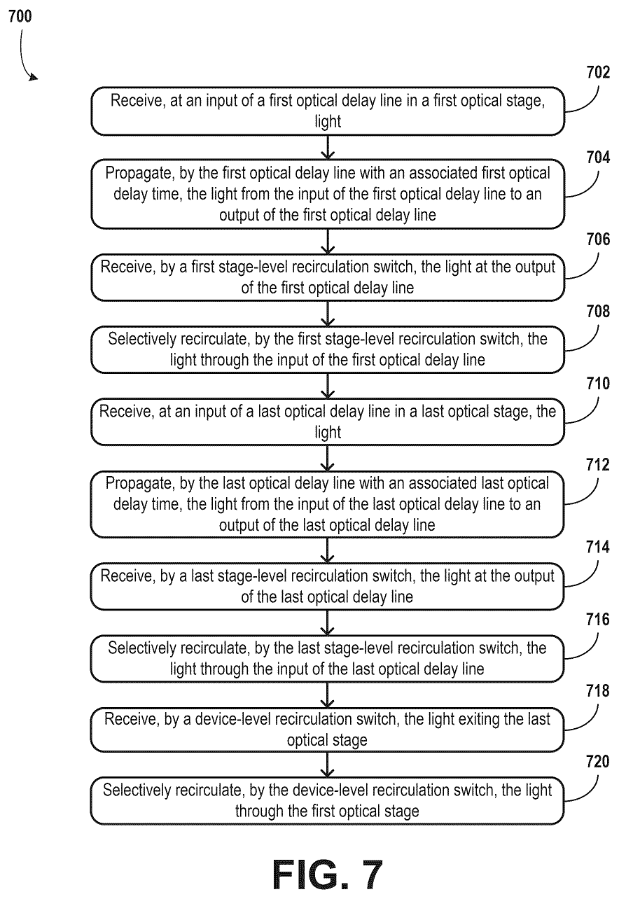

FIG. 7 is a flowchart of a method 700, according to an example embodiment. The method 700 may be performed by devices as described herein (e.g., the device 100 as shown and described with reference to FIG. 1A).

At block 702, the method 700 may include receiving, at an input of a first optical delay line in a first optical stage, light.

At block 704, the method 700 may include propagating, by the first optical delay line with an associated first optical delay time, the light from the input of the first optical delay line to an output of the first optical delay line.

At block 706, the method 700 may include receiving, by a first stage-level recirculation switch, the light at the output of the first optical delay line.

At block 708, the method 700 may include selectively recirculating, by the first stage-level recirculation switch, the light through the input of the first optical delay line.

At block 710, the method 700 may include receiving, at an input of a last optical delay line in a last optical stage, the light.

At block 712, the method 700 may include propagating, by the last optical delay line with an associated last optical delay time, the light from the input of the last optical delay line to an output of the last optical delay line.

At block 714, the method 700 may include receiving, by a last stage-level recirculation switch, the light at the output of the last optical delay line.

At block 716, the method 700 may include selectively recirculating, by the last stage-level recirculation switch, the light through the input of the last optical delay line.

At block 718, the method 700 may include receiving, by a device-level recirculation switch, the light exiting the last optical stage.

At block 720, the method 700 may include selectively recirculating, by the device-level recirculation switch, the light through the first optical stage.

### IV. CONCLUSION

One benefit of the free-space scheme described herein is that cryogenic cooling or an oven is not needed for operation. Although the system works at room temperature, due to the long path lengths it is somewhat susceptible to instability in the alignment caused by temperature variations. In some embodiments, to reduce the impact of these fluctuations, devices are encapsulated within an enclosure to provide passive stability and/or one or more active stabilization systems are incorporated (e.g., active stabilization systems as described above). Such enclosures may prevent turbulent air from entering the memory, which may reduce drifts in alignment. In addition to this reduction in drift, active stabilization systems may use a combination of an ancillary laser with piezoelectric-controlled mirrors and a quadrant cell photoreceiver (or quad-cell) to adjust the alignment of the system when drifting does occur.

Such robust, high-performance quantum memories as described herein enable several quantum communication protocols, and can provide a cornerstone of quantum repeater nodes in near-term quantum networks. Scalable, high-efficiency, and high-fidelity memories may be central in these applications. In some embodiments, the quantum memories herein boast impressive time-bandwidths, competitive storage times, high scalabilities, and a large range of operational wavelengths (a useful characteristic for early-stage networks, which might use various wavelengths of light).

The use of only free-space optical elements in the free-space delay-line type quantum memories described herein provide flexibility regarding which wavelength band(s) the memory can be used for, and additionally allow for the optimization of memory efficiency for multiple wavelength bands simultaneously. Memory efficiency and bandwidth depend on the reflective coatings of the free-space mirrors and polarizing beamsplitters in the memory and the anti-reflective coatings of the Pockels cells. Memory efficiency and bandwidth also depend on the wavelength dependence of the phase φ=2π^{nd}/λ where n is the refractive index the propagation medium (which may itself intrinsically depend on wavelength, due to dispersion in the material), d is the path length traveled, and A is the optical wavelength. Note that the refractive index n is also, to a lesser extent, wavelength-dependent (dispersion). The reflective and anti-reflective coatings described herein can be designed to accept multiple wavelength bands, and this multi-wavelength compatibility carries over into the multi-wavelength compatibility of memories described herein. Much like the multiple spatial modes supported by the memory and cavities described herein, example embodiments can support multiple wavelength modes and store broadband photons in multiple wavelength regions at the same time.

For example, free-space delay-line type quantum memories are intrinsically more broadband than any matter-based alternative (all alternative memory types), as their bandwidth is limited solely by the combined transmission bandwidth of the mirrors, Pockels cell, thin-film polarizing beam splitter, and all other free-space optical elements that form the delay line. This contrasts with matter-based memories, which rely on transduction of the photonic qubit into a matter excitation; both the transduction process, often mediated by an external optical, electrical, and/or magnetic field of limited bandwidth, and the matter excitation itself place limits on the acceptance bandwidth of the photonic qubit to be stored. Matter-based memories have these bandwidth limitations in addition to the bandwidth limitations arising from free-space optical elements, and therefore necessarily possess bandwidths strictly less than or equivalent to free-space delay-line type quantum memories.

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, operation, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step, block, or operation that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer-readable medium such as a storage device including RAM, a disk drive, a solid state drive, or another storage medium.

The computer-readable medium can also include non-transitory computer-readable media such as computer-readable media that store data for short periods of time like register memory and processor cache. The computer-readable media can further include non-transitory computer-readable media that store program code and/or data for longer periods of time. Thus, the computer-readable media may include secondary or persistent long term storage, like read-only memory (ROM), optical or magnetic disks, solid state drives, compact-disc read-only memory (CD-ROM), for example. The computer-readable media can also be any other volatile or non-volatile storage systems. A computer-readable medium can be considered a computer-readable storage medium, for example, or a tangible storage device.

Moreover, a step, block, or operation that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed:

1. A device comprising:
a plurality of cascaded optical stages coupled with one another, wherein each optical stage comprises:
an optical delay line configured to:
receive light at an input; and
propagate light from the input to an output, wherein light propagates from the input to the output with an associated optical delay time, and wherein the optical delay times associated with different optical stages are different from one another; and
a stage-level recirculation switch configured to receive light at the output of the optical delay line and selectively recirculate the light through the input of the optical delay line; and
a device-level recirculation switch configured to receive light exiting a last optical stage of the plurality of optical stages and selectively recirculate the light through a first optical stage of the plurality of optical stages.

2. The device of claim 1,
wherein at least one of the optical delay lines comprises a modified Herriott cell,
wherein the modified Herriott cell comprises:
a first mirror, wherein the first mirror is spherical;
a second mirror facing the first mirror; and
a third mirror facing the first mirror and adjacent to the second mirror,
wherein the third mirror is rotated relative to the second mirror about a first axis, and
wherein the third mirror is rotated relative to the second mirror about a second axis.

3. The device of claim 1, wherein at least one of the stage-level recirculation switches or the device-level recirculation switch is polarization-independent.

4. The device of claim 1, further comprising:
a first half-wave plate;
an input beam displacer configured to:
receive an input beam;
split the input beam into a first beam with a first spatial mode and a second beam with a second spatial mode;
provide the first beam to an input of a first optical stage of the plurality of optical stages;
provide the second beam to the first half-wave plate,
wherein the first half-wave plate is configured to:
receive the second beam from input beam displacer;
rotate a polarization of the second beam; and
provide the second beam with the rotated polarization to the input of the first optical stage of the plurality of optical stages;
an output beam displacer; and
a second half-wave plate configured to:
receive the first beam from an output of a last optical stage of the plurality of optical stages;
rotate a polarization of the first beam; and
provide the first beam with the rotated polarization to the output beam displacer,
wherein the output beam displacer configured to:
receive the first beam with the rotated polarization from the second half-wave plate;
receive the second beam with the rotated polarization from the output of the last optical stage of the plurality of optical stages; and
combine the first beam with the rotated polarization and the second beam with the rotated polarization into an output beam with a single spatial mode.

5. The device of claim 1, wherein the stage-level recirculation switch comprises a Pockels cell and a polarization-beam splitter.

6. The device of claim 1, wherein the device-level recirculation switch comprises two Pockels cells and two polarization-beam splitters.

7. The device of claim 1, wherein the stage-level recirculation switch or the device-level recirculation switch comprises an Optical Kerr Shutter (OKS), a nonlinear optical loop mirror, or a Mach-Zehnder Interferometer.

8. The device of claim 1, wherein the stage-level recirculation switch or the device-level recirculation switch comprises an all-optical switch and a polarization-beam splitter, or wherein the stage-level recirculation switch or the device-level recirculation switch comprises a photonic integrated circuit optical circuit.

9. The device of claim 1, wherein the optical delay line comprises a reflective coating, wherein a reflectivity of the reflective coating is greater than 99.995% for all wavelengths within a first wavelength range and a second wavelength range, and wherein the first wavelength range and the second wavelength range span at least 75 nm.

10. The device of claim 1, wherein the optical delay time of the optical delay line of a first optical stage of the plurality of optical stages is two times the optical delay time of the optical delay line of a second optical stage of the plurality of optical stages.

11. The device of claim 1, wherein the optical delay time of the optical delay line of a first optical stage of the plurality of optical stages is ten times the optical delay time of the optical delay line of a second optical stage of the plurality of optical stages.

12. The device of claim 1, further comprising a rack mount, wherein the plurality of cascaded optical stages and the device-level recirculation switch are mounted within the rack mount.

13. The device of claim 1, wherein each optical stage of the plurality of optical stages comprises an optical fiber, wherein each of the stage-level recirculation switches comprises a fiber-optic switch, wherein the device-level recirculation switch comprises a fiber-optic switch.

14. The device of claim 1, wherein each optical stage of the plurality of optical stages comprises a first optical fiber and a second optical fiber spliced together into a single loop, wherein the first optical fiber comprises a silica fiber, and wherein the second optical fiber comprises a dispersion compensating fiber.

15. A device comprising:
a plurality of cascaded optical stages coupled with one another, wherein each optical stage comprises:
an optical delay line configured to:
receive light at an input; and
propagate light from the input to an output, wherein light propagates from the input to the output with an associated optical delay time, and wherein the optical delay times associated with different optical stages are different from one another; and
at least one active temperature stabilizer comprising:
a photodetector configured to detect one or more calibration signals indicative of a change in an optical path length or an optical alignment associated with the optical delay line in one of the optical stages; and
an actuator configured to, in response to the photodetector detecting the change in the optical path length or the optical alignment, counteract the change in the optical path length or the optical alignment by adjusting the optical path length or adjusting the optical alignment.

16. The device of claim 15,
wherein at least one of the optical delay lines comprises a modified Herriott cell,
wherein the modified Herriott cell comprises:
a first mirror, wherein the first mirror is spherical;
a second mirror facing the first mirror; and
a third mirror facing the first mirror and adjacent to the second mirror,
wherein the third mirror is rotated relative to the second mirror about a first axis, and
wherein the third mirror is rotated relative to the second mirror about a second axis.

17. The device of claim 16, wherein the actuator comprises:
a piezoelectric chip or a motorized linear actuator; and
one or more stages or mounts configured to adjust a tip angle, a tilt angle, or a position of the third mirror.

18. The device of claim 16, wherein the photodetector comprises a position-sensitive detector (PSD).

19. The device of claim 18, wherein the PSD comprises a quadrant cell photoreceiver.

20. A method comprising:
receiving, at an input of a first optical delay line in a first optical stage, light;
propagating, by the first optical delay line with an associated first optical delay time, the light from the input of the first optical delay line to an output of the first optical delay line;
receiving, by a first stage-level recirculation switch, the light at the output of the first optical delay line;
selectively recirculating, by the first stage-level recirculation switch, the light through the input of the first optical delay line;
receiving, at an input of a last optical delay line in a last optical stage, the light;
propagating, by the last optical delay line with an associated last optical delay time, the light from the input of the last optical delay line to an output of the last optical delay line;
receiving, by a last stage-level recirculation switch, the light at the output of the last optical delay line;
selectively recirculating, by the last stage-level recirculation switch, the light through the input of the last optical delay line;
receiving, by a device-level recirculation switch, the light exiting the last optical stage; and
selectively recirculating, by the device-level recirculation switch, the light through the first optical stage.
